(19) United States
(12) Patent Application Publication
(10) Pub. No.: US 2026/0322091 A1
(43) Pub. Date: Oct. 15, 2026

(54) Modular Stackable Wire Organizing Apparatus

(71) Applicant: Darrell James Haslam, Ajax (CA)

(72) Inventor: Darrell James Haslam, Ajax (CA)

(21) Appl. No.: 19/464,272

(22) Filed: Jan. 29, 2026

Related U.S. Application Data
(60) Provisional application No. 63/752,351, filed on Jan. 31, 2025.

(51) Int. Cl. H02G 3/32

(52) U.S. Cl. CPC H02G 3/32

(57) ABSTRACT

A modular wire organizer has a wall-mountable primary member and one or more secondary members stacked on the primary member. The primary member holds a wire between the member and a wall and has two legs joined by a bridge. A channel beneath the bridge passes through front and rear surfaces to route the wire. Each leg has a fastener hole with a counterbore and a connection port opening from the top surface. Each secondary member has two legs joined by a bridge with a through channel. Connection pegs extend from the secondary member bottom and insert into the connection ports wherein ribs on the pegs increase retention. Secondary members also have matching connection ports so additional secondary members stack, enabling organized routing of multiple electrical wires.

### FIELD OF THE INVENTION

The present invention relates generally to electrical wiring. More specifically, the present invention is a modular organization device for stacking multiple electrical wires running down the same stud.

### BACKGROUND OF THE INVENTION

Electrical wiring is a fundamental component of residential, commercial, and industrial construction. Properly routing and securing wiring within walls is essential for both safety and performance. Typically, electrical wires are installed by running them through drilled holes in wooden or metal studs, stapling them to the side of studs, or securing them with other fasteners. However, as electrical systems have become more complex and the number of circuits in buildings has increased, the need to efficiently organize and protect wiring has grown.

Historically, electricians have used simple staples or clips to attach wires to studs, ensuring that they remain in place and do not sag or interfere with drywall installation. However, these methods have inherent limitations, particularly when multiple wires need to be secured in a confined space. Electrical codes regulate how wires should be routed to prevent overheating, mechanical damage, and electromagnetic interference. As code requirements evolve, there is a need for improved wire management solutions that facilitate compliance while maintaining efficiency in installation.

The prior art primarily relies on individual fasteners, staples, or nail-on clips to secure each wire separately. When multiple wires need to be routed along a single stud, existing methods require separate fasteners for each wire, leading to cluttered and uneven stacking. This can create difficulties in drywall installation and potential code violations.

Attaching each wire individually increases installation time, especially in high-density wiring applications such as panel-fed circuits, data cabling, and home automation systems. Electrical codes often require that wires be spaced apart to prevent heat buildup and excessive bundling. The traditional method of randomly securing wires with staples does not inherently provide a structured or code-compliant arrangement. Staples and clips exert pressure on the wire insulation, which can lead to mechanical damage over time.

Excessive force may also deform the conductor, leading to electrical faults. Once installed, traditional fasteners make it difficult to modify or inspect wiring. If an electrician needs to add or remove a wire, the existing setup often requires dismantling multiple staples or clips, increasing labor costs and effort. Given these challenges, there is a clear need for an improved electrical wire stacking apparatus that organizes and secures multiple wires efficiently, ensures compliance with evolving electrical codes, and simplifies both installation and future modifications.

The present invention addresses the deficiencies of prior art by introducing a wire stacking apparatus that allows multiple wires to be secured in an organized and code-compliant manner. The invention consists of a base member and one or more connected members, each forming a U-shaped mount. The base member attaches directly to the stud, while additional connected members “piggyback” onto the base member and adjacent connected members, securing multiple wires in an orderly fashion. By maintaining consistent spacing between wires and preventing excessive bundling, the invention helps electricians adhere to modern electrical codes while reducing the risk of heat buildup and insulation wear. The modular design allows for quick and easy attachment of multiple wires without the need for individual staples or clips, significantly improving installation efficiency. Unlike staples that may puncture or compress wire insulation, the U-shaped mounts provide secure yet gentle retention of wires, reducing the risk of damage over time. The design allows for easy removal or addition of wires by simply detaching the connected members, making it more convenient for electricians to make adjustments or conduct inspections. By maintaining a structured arrangement of wires along a stud, the invention simplifies wall finishing processes, prevents interference between electrical and other building systems, and enhances the overall aesthetic and safety of electrical installations. Further, an additional objective of the present invention is to enable a user to provide a safeguard when establishing distance from heating ducts.

In summary, the present invention provides a superior alternative to traditional wire securing methods by introducing an efficient, compliant, and easy-to-use wire stacking apparatus. The modular system ensures that wires are neatly organized, protected from mechanical stress, and accessible for future modifications, ultimately improving both the safety and functionality of electrical installations.

### BRIEF DESCRIPTION OF THE DRAWINGS

FIG. 1 is a perspective view of the present invention comprising a plurality of secondary members.

FIG. 2 is a front view of the present invention showing electrical wires traversing the channels.

FIG. 3 is a perspective view of the primary member of the present invention.

FIG. 4 is a front view of the primary member of the present invention.

FIG. 5 is a bottom perspective view of the primary member of the present invention.

FIG. 6 is a top view of the primary member of the present invention.

FIG. 7 is a front view of the secondary member of the present invention.

FIG. 8 is a bottom perspective view of the secondary member of the present invention.

FIG. 9 is a top perspective view of the secondary member of the present invention.

FIG. 10 is an exploded view of the present invention.

FIG. 11 is a front view of the present invention showing hidden lines.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a modular stackable wire organizing apparatus 1, embodiments of the present disclosure are not limited to use only in this context.

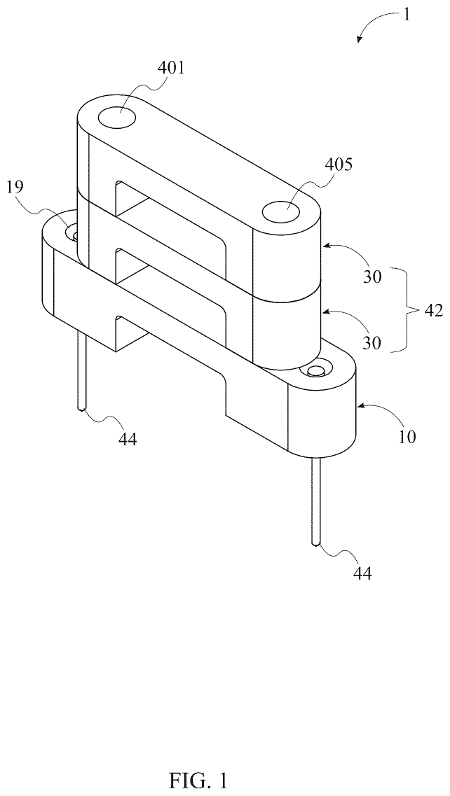

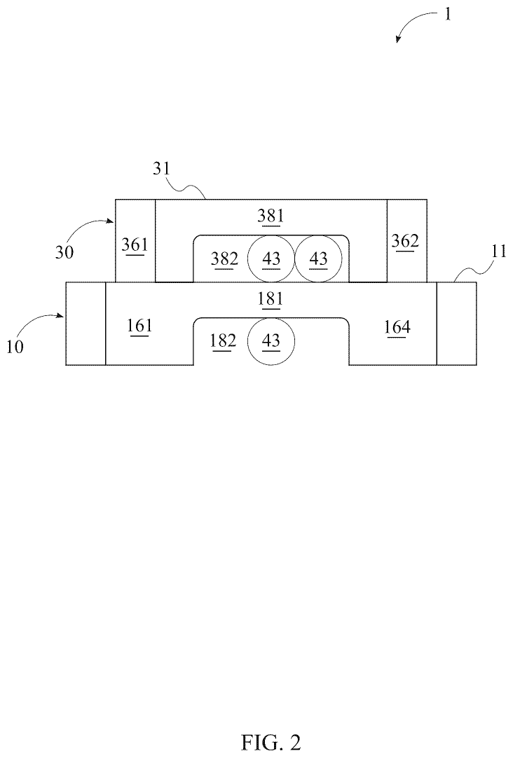

As shown in FIG. 1-2, the present invention is a modular stackable wire organizing apparatus 1 comprising a primary member 10 and at least one secondary member 30. In the preferred embodiment of the present invention, the primary member 10 is fastened to a wall and the at least one secondary member 30 is secured to the primary member 10. Further, in the preferred embodiment of the present invention, the primary member 10 is fastened to a wall such that a wire 43 is secured to the wall wherein the wire 43 is interposed between the wall and the primary member 10. Additionally, in the preferred embodiment of the present invention, the secondary member 30 is configured to secure a wire 43 interposed between the primary member 10 and the secondary member 30. In the context of the present invention, as shown in FIG. 1, the at least one secondary member 30 is “stacked” atop the primary member 10. In some embodiments of the present invention, the at least one secondary member 30 comprises a plurality of secondary members 42 wherein each subsequent secondary member 30 is connectedly “stacked” atop an adjacent secondary member 30, as shown in FIG. 1.

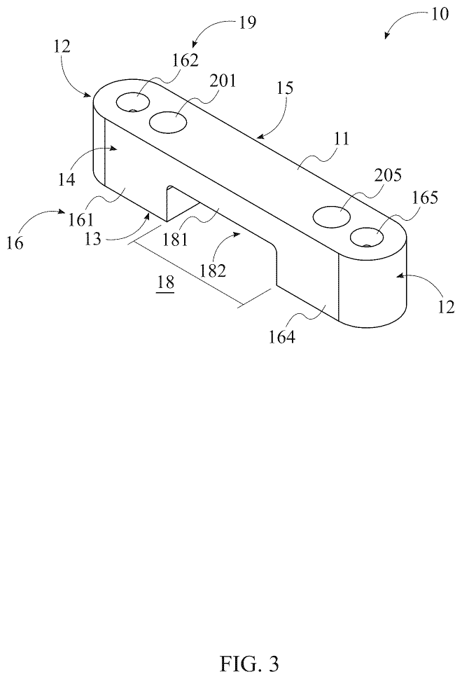

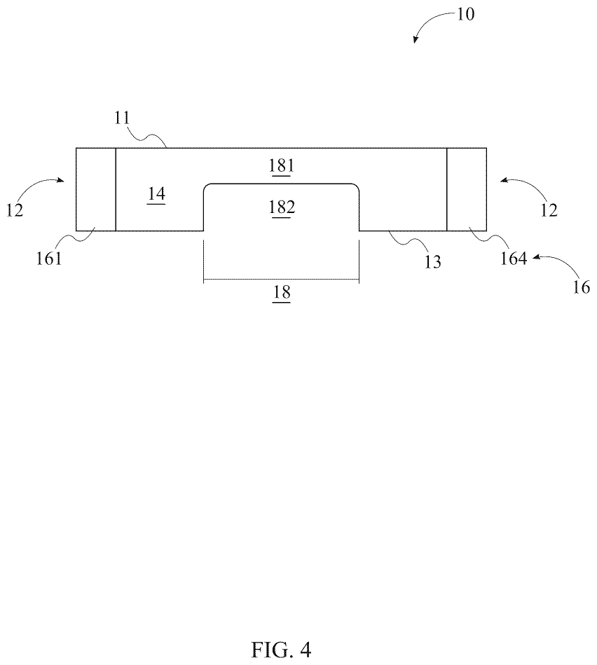

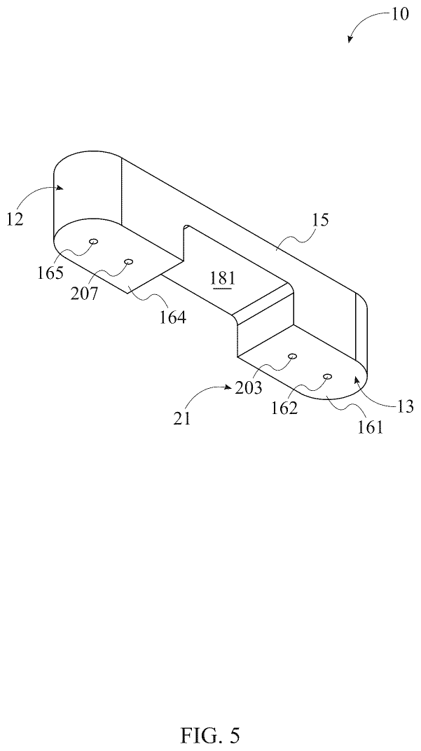

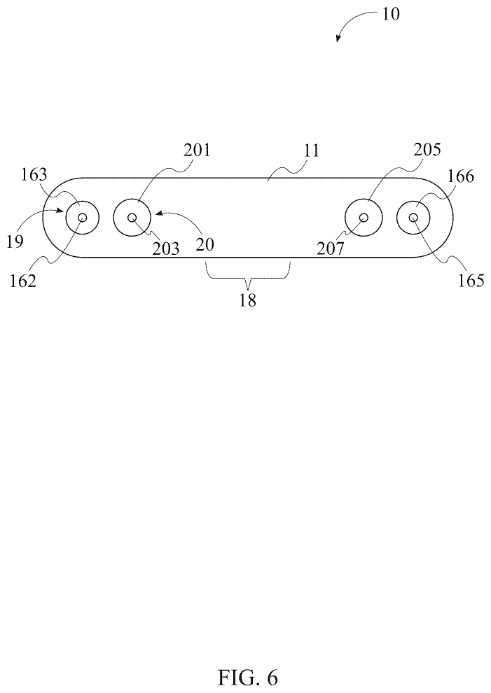

In the preferred embodiment of the present invention, as shown in FIG. 3-6, the primary member 10 is rectangular comprising a top surface 11, a plurality of distal ends 12, a bottom portion 13, a front surface 14, and a rear surface 15. In the context of the present invention, the top surface 11 of the primary member 10 is a planar surface opposite the bottom portion 13 of the primary member 10. Likewise, the front surface 14 of the primary member 10 is a planar surface opposite the rear surface 15 of the primary member 10, wherein said rear surface 15 is a planar surface. In the context of the present invention, the plurality of distal ends 12 of the primary member 10, numbering two distal ends: a first distal end and a second distal end, are opposing distal ends of the rectangular geometry of the primary member 10. Furthermore, the primary member 10 comprises a plurality of legs 16 and a proximal portion 18. In the context of the present invention, the proximal portion 18 is a central portion of the primary member 10, interposed between the plurality of distal ends 12 wherein the plurality of legs 16, comprising a first leg 161 and a second leg 164, are disposed at the first distal end and the second distal end, respectively.

In the preferred embodiment of the present invention, as shown in FIG. 3-6, the primary member 10 comprises a bridge 181 and a channel 182, located at the proximal portion 18. In the context of the present invention, the bridge 181 is a member spanning a distance between the plurality of legs 16 wherein the channel 182 is a cutout beneath the bridge 181, extending through the front surface 14 and the rear surface 15. In the preferred embodiment of the present invention, a topmost portion of the bridge 181 is coplanar with the top surface 11 of the primary member 10, along with a top most portion of the plurality of legs 16. Further, in the context of the present invention, the plurality of legs 16 extend from the top surface 11 to a bottom-most plane of the primary member 10. In the context of the present invention, the bottom portion 13 includes the bottom surfaces of the plurality of legs 16 and the bottom surface of the bridge 181.

Additionally, as shown in FIG. 3-6, in the context of the present invention, the primary member 10 further comprises a plurality of connection ports 20 and a plurality of fastener holes 19. In the context of the present invention, the plurality of connection ports 20 are holes extending a depth into each leg of the plurality of legs 16, from the top surface 11. Furthermore, in the context of the present invention, the plurality of fastener holes 19 extends through each of the plurality of legs 16. Specifically, in the preferred embodiment of the present invention, the plurality of connection ports 20 comprises a first connection port 201 and a second connection port 205 wherein the first connection port 201 extends a depth into the first leg 161 and the second connection port 205 extends a depth into the second leg 164. Likewise, in the preferred embodiment of the present invention, the plurality of fastener holes 19 comprises a first fastener hole 162 and a second fastener hole 165 wherein the first fastener hole extends through the first leg 161 and the second fastener hole 165 extends through the second leg 164. In the preferred embodiment of the present invention, each of the fastener holes of the plurality of fastener holes 19 comprises a counter bore such that the first fastener hole 162 comprises a first counter bore 163 and the second fastener hole 165 comprises a second counter bore 166.

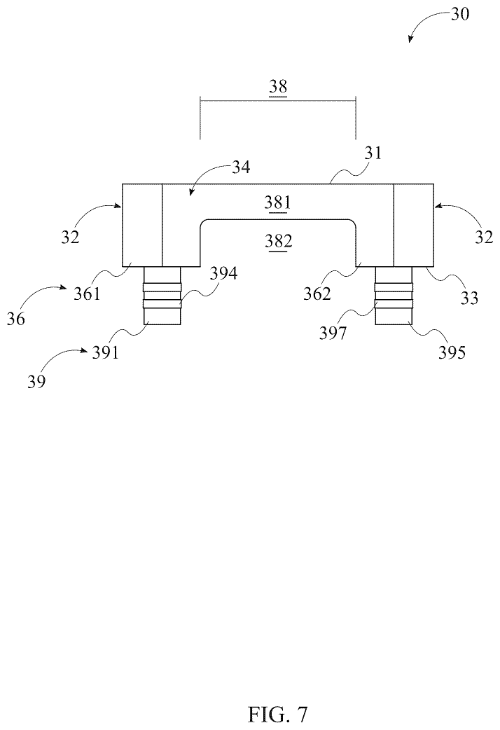

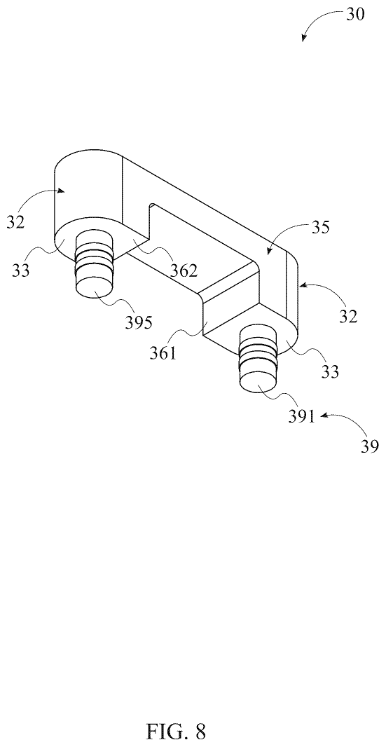

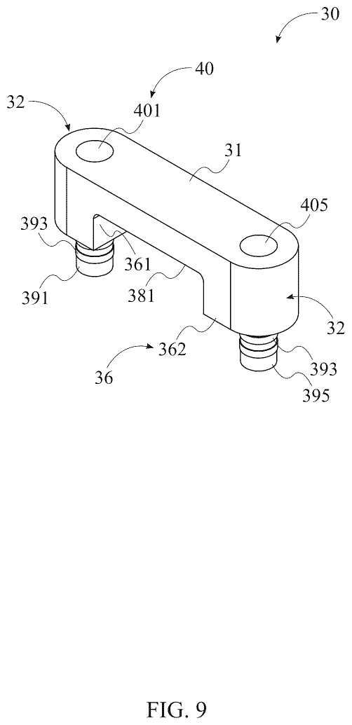

As shown in FIG. 7-9, the at least one secondary member 30 comprises a top surface 31, a plurality of distal ends 32, a bottom portion 33, a front surface 34, and a rear surface 35. In the context of the present invention, the top surface 31 of the at least one secondary member 30 is a planar surface opposite the bottom portion 33 of the at least one secondary member 30. Likewise, the front surface 34 of the at least one secondary member 30 is a planar surface opposite the rear surface 35 of the at least one secondary member 30, wherein said rear surface 35 is a planar surface. In the context of the present invention, the plurality of distal ends 32 of the at least one secondary member 30, numbering two distal ends: a first distal end and a second distal end, are opposing distal ends of the rectangular geometry of the at least one secondary member 30. Furthermore, the at least one secondary member 30 comprises a plurality of legs 36 and a proximal portion 38. In the context of the present invention, the proximal portion 38 is a central portion of the at least one secondary member 30, interposed between the plurality of distal ends 32 wherein the plurality of legs 36, comprising a first leg 361 and a second leg 362, are disposed at the first distal end and the second distal end, respectively.

In the preferred embodiment of the present invention, as shown in FIG. 7-9, the at least one secondary member 30 further comprises a bridge 381 and a channel 382, located at the proximal portion 38 of the at least one secondary member 30. In the context of the present invention, the bridge 381 of the at least one secondary member 30 is a member spanning a distance between the plurality of legs 36 wherein the channel 382 is a cutout beneath the bridge 381, extending through the front surface 34 and the rear surface 35 of the at least one secondary member 30. In the preferred embodiment of the present invention, a topmost portion of the bridge 381 of the at least one secondary member 30 is coplanar with the top surface 31 of the at least one secondary member 30, along with a top most portion of the plurality of legs 36. Further, in the context of the present invention, the plurality of legs 36 of the at least one secondary member 30 extend from the top surface 31 to a bottom-most plane of the at least one secondary member 30. In the context of the present invention, the bottom portion 33 of the at least one secondary member 30 includes the bottom surfaces of the plurality of legs 36 and the bottom surface of the bridge 381.

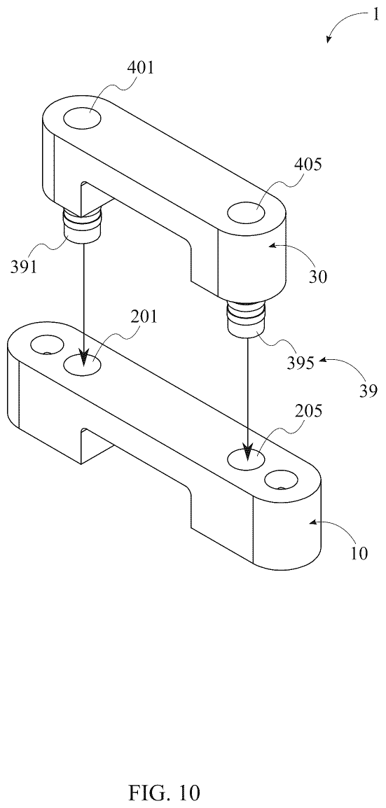

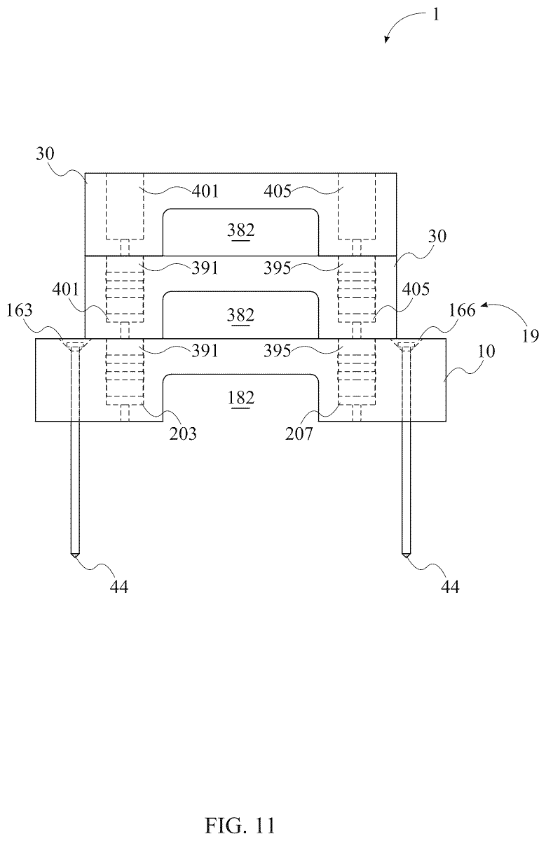

Additionally, as shown in FIG. 7-9, in the context of the present invention, the plurality of legs 36 of the secondary member 30 comprises a plurality of connection pegs 39 wherein the plurality of connection pegs 39 extend from the bottom portion 33 of the plurality of legs 36. In the preferred embodiment of the present invention, the plurality of connection pegs 39 comprises a first connection peg 391 and a second connection peg 395 wherein the first connection peg 391 extends from the bottom portion 33 of the first leg 361 and the second connection peg 395 extends from the bottom portion 33 of the second leg 362. In the context of the present invention, as shown in FIG. 10-11, each connection peg 39 of the at least one secondary member 30 comprises a size corresponding to the size of each respective connection port 20 of the primary member 10 such that the plurality of connection pegs 39 are insertable to the plurality of connection ports 20. Additionally, in the preferred embodiment of the present invention, each of the connection pegs 39 comprises at least one rib 393,397 protruding a perimeter of the respective connection peg 391,395. In such embodiments, the at least one rib 393,397 provides a tighter fit between the connection peg 391,395 and the respective connection port as to prevent decoupling. In some embodiments of the present invention, the at least one rib 393,397 comprises a plurality of ribs 394,398.

Additionally, as shown in FIG. 10-11, in the preferred embodiment of the present invention, the at least one secondary member 30 further comprises a plurality of connection ports 40. In the context of the present invention, the plurality of connection ports 40 of the secondary member 30 comprise a first connection port 401 and a second connection port 405 wherein the first connection port 401 extends a depth into the first leg 361 of the at least one secondary member 30 and the second connection port 405 extends a depth into the second leg 362 of the at least one secondary member 30. In the preferred embodiment of the present invention, the plurality of connection ports 40 of the at least one secondary member 30 extend from the bottom portion 33 of the plurality of legs 36 of the at least one secondary member 30, coaxially aligned within the plurality of connection pegs 39 of the at least one secondary member 30. In the preferred embodiment of the present invention, the plurality of connection ports 20 of the primary member 10 and the plurality of connection ports 40 of the at least one secondary member 30 are congruent such that the plurality of connection pegs 39 is corresponsive to both the plurality of connection ports 20 of the primary member 10 and the plurality of connection ports 40 of the at least one secondary member 30, thereby enabling a plurality 42 of secondary members 30 to couple together.

In the preferred embodiment of the present invention, the modular stackable wire organizing apparatus 1 secures electrical wires 43 within the present invention wherein said electrical wires 43 are fed through the channels 182,382 of both the primary member 10 and the at least one secondary member 30, as shown in FIG. 2. Additionally, in the preferred embodiment of the present invention, the modular stackable wire organizing apparatus 1 is fastened such that a plurality of fasteners 44 extend (i.e. nailed, screwed, etc.) through the plurality of fastener holes 19 of the primary member 10, as shown in FIG. 11. In the preferred embodiment of the present invention, the counter bores 163,166 of the plurality of fastener holes 19 enable the head of the fastener 44 to sit below the top surface 11 of the primary member 10.

Although the invention has been explained in relation to its preferred embodiment, it is to be understood that many other possible modifications and variations can be made without departing from the spirit and scope of the invention.

What is claimed is:

1. A modular stackable wire organizing apparatus comprising:
a primary member; and
an at least one secondary member;
wherein:
the primary member comprises:
a plurality of primary connection ports; and
a primary channel; and
the at least one secondary member comprises:
a plurality of connection pegs;
a plurality of secondary connection ports; and
a secondary channel;
the plurality of primary connection ports extend a depth into the primary member from a top surface;
the plurality of connection pegs extend from a bottom portion of the at least one secondary member;
the plurality of secondary connection ports extend a depth into the at least one secondary member; and
the plurality of connection pegs are configured to couple to the plurality of primary connection ports.

2. The modular stackable wire organizing apparatus, as claimed in claim 1, wherein:
the plurality of primary connection ports comprises a first primary connection port and a second primary connection port wherein said first primary connection port and said second primary connection port are offset each other; and
the primary channel is interposed between the first primary connection port and the second primary connection port.

3. The modular stackable wire organizing apparatus, as claimed in claim 2, wherein:
the plurality of secondary connection ports comprises a first secondary connection port and a second secondary connection port wherein said first secondary connection port and said second secondary connection port are offset each other; and
the secondary channel is interposed between the first secondary connection port and the second secondary connection port.

4. The modular stackable wire organizing apparatus, as claimed in claim 3, wherein:
the plurality of connection pegs comprises a first connection peg and a second connection peg.

5. The modular stackable wire organizing apparatus, as claimed in claim 4, wherein:
the first secondary connection port coaxially aligns with the first connection peg of the at least one second member; and
the second secondary connection port coaxially aligns with the second connection peg of the at least one second member.

6. The modular stackable wire organizing apparatus, as claimed in claim 4, wherein:
the first connection peg extends from a first leg of the at least one secondary member;
the second connection peg extends from a second leg of the at least one secondary member; and
a bridge extends interposed between the first leg and the second leg such that the bridge is adjacent to the channel.

7. The modular stackable wire organizing apparatus, as claimed in claim 4, wherein the plurality of connection pegs comprise an at least one rib.

8. The modular stackable wire organizing apparatus, as claimed in claim 7, wherein the at least one rib comprises a plurality of ribs.

9. The modular stackable wire organizing apparatus, as claimed in claim 3, wherein:
the primary member further comprises a plurality of legs;
the plurality of legs comprises a first leg and a second leg;
the first primary connection port extends a depth into the first leg of the primary member;
the second primary connection port extends a depth into the second leg of the primary member; and
the plurality of legs further comprise a plurality of fastener holes wherein said fastener holes extend through each leg.

10. The modular stackable wire organizing apparatus, as claimed in claim 9 wherein:
the primary member further comprises a bridge;
the bridge of the second member extends interposed between the first leg and the second leg of the primary member; and
a topmost portion of the bridge is coplanarly aligned with the top surface of the primary member.

11. A modular stackable wire organizing apparatus comprising:
a primary member; and
an at least one secondary member;
wherein:
the primary member comprises:
a plurality of legs;
a primary channel; and
a plurality of primary connection ports;
the at least one secondary member comprises:
a plurality of legs;
a secondary channel;
a plurality of connection pegs; and
a plurality of secondary connection ports;
the plurality of legs of the primary member are offset each other;
the primary channel is interposed between the plurality of legs of the primary member;
the plurality of primary connection ports extend a depth into the plurality of legs of the primary member;
the plurality of legs of the primary member are offset each other;
the secondary channel is interposed between the plurality of legs of the secondary member;
the plurality of connection pegs extend from a bottom portion of the plurality of legs of the secondary member; and
the plurality of secondary connection ports extend a depth into the plurality of legs of the secondary member.

12. The modular stackable wire organizing apparatus, as claimed in claim 11, wherein:
the plurality of legs of the primary member comprises a first leg and a second leg; and
the plurality of legs of the secondary member comprises a first leg and a second leg.

13. The modular stackable wire organizing apparatus, as claimed in claim 12, wherein:
the plurality of primary connection ports comprises:
a first primary connection port; and
a second secondary connection port;
the first primary connection port extends a depth into the first leg of the primary member;
the second primary connection port extends a depth into the second leg of the primary member.

14. The modular stackable wire organizing apparatus, as claimed in claim 12, wherein:
the plurality of secondary connection ports comprises:
a first secondary connection port; and
a second secondary connection port;
the plurality of connection pegs comprises:
a first connection peg; and
a second connection peg;
the first secondary connection port extends a depth into the first leg of the secondary member;
the second secondary connection port extends a depth into the second leg of the secondary member;
the first connection peg extends from the bottom portion of the first leg of the secondary member; and
the second connection peg extends from the bottom portion of the second leg of the secondary member.

15. The modular stackable wire organizing apparatus, as claimed in claim 14, wherein:
the first connection peg is coaxially aligned with the first connection port of the secondary member; and
the second connection peg is coaxially aligned with the second connection port of the secondary member.

16. The modular stackable wire organizing apparatus, as claimed in claim 14, wherein:
the plurality of primary connection ports comprises:
a first primary connection port; and
a second secondary connection port;
the first connection peg is configured to insert into the first primary connection port; and
the second connection peg is configured to insert into the second primary connection port.

17. The modular stackable wire organizing apparatus, as claimed in claim 16, wherein each connection peg of the plurality of connection pegs comprises an at least one rib.

18. A modular stackable wire organizing apparatus comprising:
a primary member; and
an at least one secondary member;
wherein:
the primary member comprises:
a plurality of primary connection ports
a primary channel; and
a plurality of fastener holes;
the at least one secondary member comprises:
a plurality of connection pegs;
a secondary channel; and
a plurality of secondary connection ports;
the plurality of primary connection ports extend a depth into the primary member;
the plurality of primary connection ports comprise a first primary connection port and a second primary connection port wherein the first primary connection port and the second primary connection port are offset;
the primary channel is interposed between the plurality of primary connection ports;
the plurality of fastener holes extend through the primary member, proximate the plurality of primary connection ports;
the plurality of connection pegs of the at least one secondary member extend downward from a bottom portion of the at least one secondary member;
the plurality of connection pegs are configured to insert into the plurality of primary connection ports;
the plurality of secondary connection ports comprise a first secondary connection port and a second secondary connection port wherein the first secondary connection port and the second secondary connection port are offset; and
the secondary channel is interposed between the plurality of secondary connection ports; and
when connected, the primary member and the secondary member are aligned such that the first primary connection port is coaxially aligned with the first secondary connection port and the second primary connection port is coaxially aligned with the second secondary connection port.

19. The modular stackable wire organizing apparatus, as claimed in claim 18, wherein each connection peg of the plurality of connection pegs comprises an at least one rib.

20. The modular stackable wire organizing apparatus, as claimed in claim 18, wherein each fastener hole of the plurality of fastener holes comprises a counter bore.
